(19) United States
(12) Patent Application Publication
(10) Pub. No.: US 2018/0363496 A1
(43) Pub. Date: Dec. 20, 2018

(54) SYSTEMS AND METHODS FOR CLEANING BLADES AND STATOR VANES IN A GAS TURBINE ENGINE

(71) Applicant: General Electric Company, Schenectady, NY (US)

(72) Inventors: Zachary L. Walters, Woodruff, SC (US); Maxwell E. Miller, Simpsonville, SC (US); Robert E. Huth, Greenville, SC (US)

(73) Assignee: General Electric Company, Schenectady, NY (US)

(21) Appl. No.: 15/422,513

(22) Filed: Feb. 2, 2017

(51) Int. Cl. F01D 25/00; B08B 1/00

(52) U.S. Cl. CPC F01D 25/002; F04D 29/703; B08B 1/006

(57) ABSTRACT

A device for cleaning blades in a turbomachine is disclosed. The device may include a frame, a cleaning jaw pivotably attached to the frame, opposing cleaning pads attached to a distal end of the cleaning jaw, a cleaning pad actuator attached to the frame for actuating the opposing cleaning pads, and at least one handle attached to the frame.

### FIELD

The disclosure relates generally to turbomachines and more particularly relates to systems and methods for cleaning compressor or turbine blades and vanes (referred to collectively as blades) in a turbomachine, such as a gas turbine engine or the like.

### BACKGROUND

Blades in a gas turbine engine, such as the blades in a compressor or turbine, may be periodically cleaned by hand. This process may be time consuming, labor intensive, and possibly hazardous. For example, due to the geometry and sharp edges of the blades, the laborers may wear steel mesh gloves up to their elbows, which may make the cleaning process even more difficult and time consuming.

### BRIEF DESCRIPTION

According to an embodiment, there is disclosed a device for cleaning blades in a turbomachine. The device may include a frame, a cleaning jaw pivotably attached to the frame, opposing cleaning pads attached to a distal end of the cleaning jaw, a cleaning pad actuator attached to the frame for actuating the opposing cleaning pads, and at least one handle attached to the frame.

According to another embodiment, there is disclosed a device for cleaning blades in a turbomachine. The device may include a frame, a first elongated arm pivotably attached to the frame and a second elongated arm pivotably attached to the frame, a first cleaning pad attached to a distal end of the first elongated arm and a second cleaning pad attached to a distal end of the second elongated arm, an oscillator in mechanical communication with the first cleaning pad and the second cleaning pad, and at least one handle attached to the frame.

Further, according to another embodiment, there is disclosed a method for cleaning a blade in a turbomachine. The method may include opening a cleaning jaw pivotably attached to a frame, positioning cleaning pads attached to a distal end of the cleaning jaw about the blade, closing the cleaning jaw so that the cleaning pads engage opposite sides of the blade, and actuating a cleaning pad actuator for movement of the cleaning pads to clean the blade.

Other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 depicts of an example gas turbine engine according to an embodiment.

FIG. 2 depicts a device for cleaning blades in a turbomachine according to an embodiment.

FIG. 3 depicts a device for cleaning blades in a turbomachine according to an embodiment.

FIG. 4 depicts a portion of a device for cleaning blades in a turbomachine according to an embodiment.

FIG. 5 depicts a portion of a device for cleaning blades in a turbomachine according to an embodiment.

FIG. 6 depicts a portion of a device for cleaning blades in a turbomachine according to an embodiment.

FIG. 7 depicts a device for cleaning blades in a turbomachine according to an embodiment.

FIG. 8 depicts a device for cleaning blades in a turbomachine according to an embodiment.

FIG. 9 depicts a device for cleaning blades in a turbomachine according to an embodiment.

### DETAILED DESCRIPTION

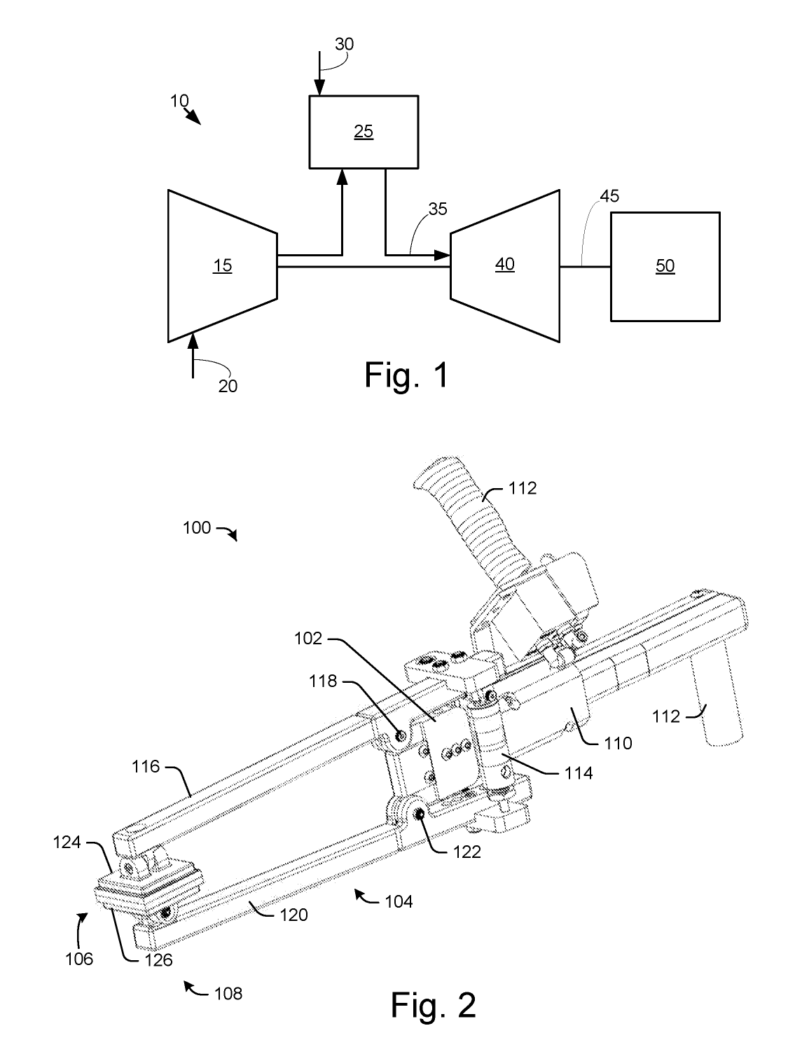

The systems and methods described herein may be used to claims blades in a turbomachine. The blades may be disposed in a compressor or a turbine. Any device with blades may utilize the systems and methods disclosed herein to clean the blades. In some instances, the turbomachine may be a gas turbine engine. Any industrial turbomachine may be used. Referring now to the drawings, in which like numerals refer to like elements throughout the several views, FIG. 1 depicts a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

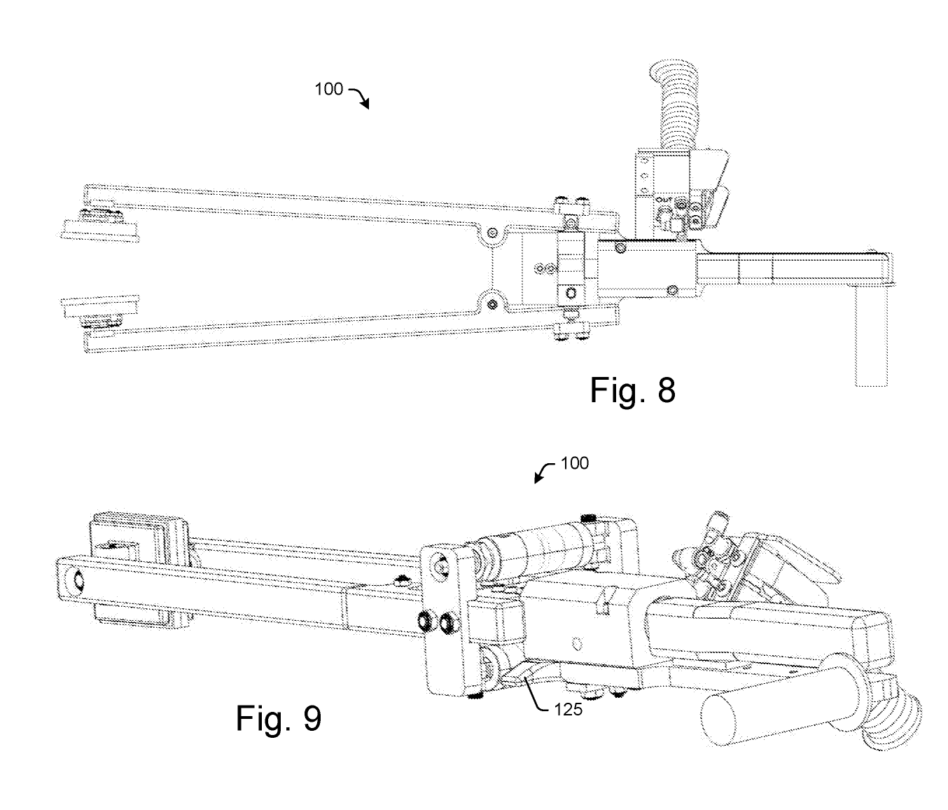

FIGS. 2, 8, and 9 depict a device 100 for cleaning blades in a turbomachine, such as a gas turbine engine. In some instances, the blades may be disposed within the compressor 15 of the gas turbine engine 10. In other instances, the blades may be disposed within the turbine 40 of the gas turbine engine 10. The device 100 may include a frame 102, a cleaning jaw 104 pivotably attached to the frame 102, opposing cleaning pads 106 attached to a distal end 108 of the cleaning jaw 104, a cleaning pad actuator 110 attached to the frame 102 for actuating the opposing cleaning pads 106, and at least one handle 112 attached to the frame 102. The device 100 also may include a cleaning jaw actuator 114 in mechanical communication with the cleaning jaw 104 for opening and closing the cleaning jaw 104.

In some instances, the cleaning jaw 104 may include a first elongated arm 116 pivotably attached to the frame 102 at a first pivot point 118. Similarly, the cleaning jaw 104 may include a second elongated arm 120 pivotably attached to the frame 102 at a second pivot point 122. In addition, the opposing cleaning pads 106 may include a first cleaning pad 124 attached to a distal end 108 of the first elongated arm 116 and a second cleaning pad 126 attached to a distal end 108 of the second elongated arm 120.

In certain embodiments, the cleaning pad actuator 110 may be an oscillator. In some instances, the oscillator may be a pneumatic oscillator, an electrical oscillator, or gas powered oscillator. The oscillator may be any size, shape, or configuration. The oscillator may be any device capable of creating oscillating movement. The oscillator may be attached to the frame 102, the cleaning jaw 104, and/or the cleaning pads 106. In this manner, the oscillator may directly or indirectly cause the cleaning pads 106 to oscillate, vibrate, and/or rotate, which in turn may facilitate cleaning of the blades. In other instances, the oscillator may be in mechanical linkage to the cleaning pads 106 or directly attached to the cleaning pads 106. The oscillation of the oscillator may cause the cleaning pads 106 to vibrate and/or rotate. The oscillator may be actuated by one or more control buttons disposed about the handle 112.

The cleaning jaw actuator 114 may be a piston. The piston may be a pneumatic piston, an electric piston, or a gas powered piston. The piston may be any size, shape, or configuration. The piston may be any device capable of creating linear movement. The piston may be attached via a mechanical linkage or directly to the first elongated arm 116 and the second elongated arm 120. In this manner, the piston may facilitate opening and closing of the cleaning jaw 104. For example, as the piston moves, the first elongated arm 116 may pivot about the first pivot point 118 and the second elongated arm 120 may pivot about the second pivot point 122. This in turn may cause the cleaning pads 106 to open and close. The piston may be actuated by one or more control buttons disposed about the handle 112.

In some instances, the device 100 may include a block 125. The block 125 may limit rotation of the device 100. In addition, the block 125 may enable a user to add pressure to the opposing cleaning pads 106.

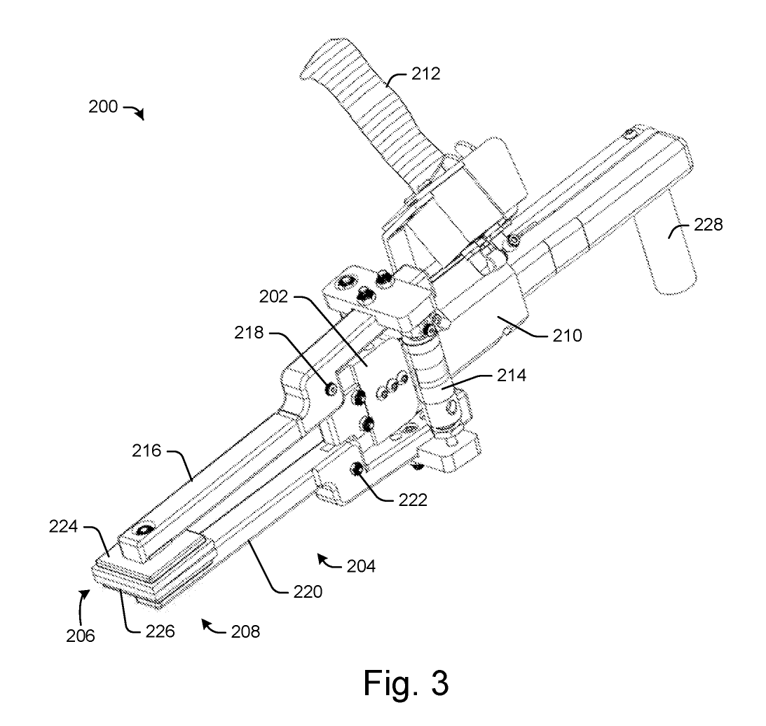

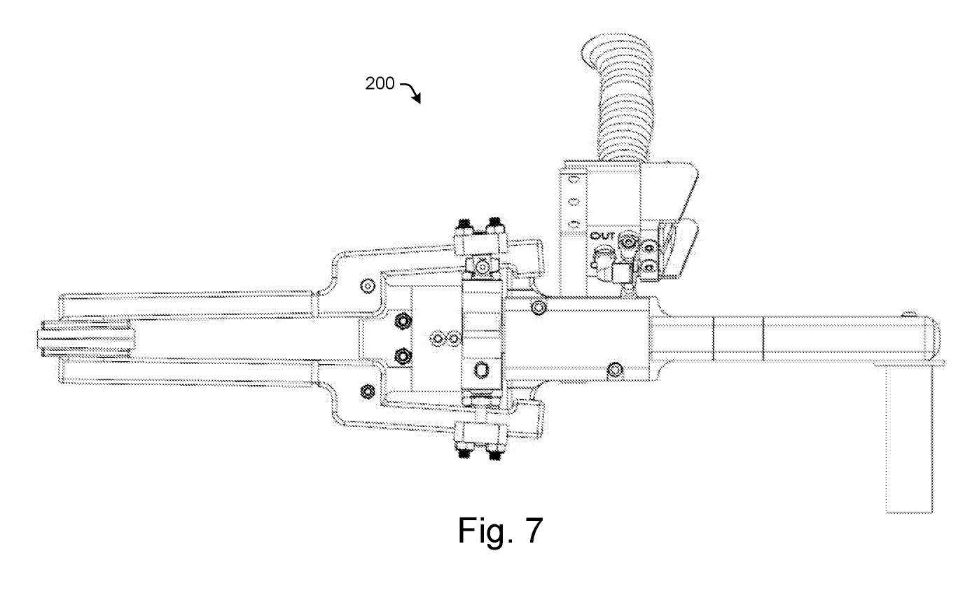

FIGS. 3 and 7 depict another example embodiment of a device 200 for cleaning blades in a gas turbine engine. The device 200 is similar to the device 100. For example, the device 200 may include a frame 202, a cleaning jaw 204 pivotably attached to the frame 202, opposing cleaning pads 206 attached to a distal end 208 of the cleaning jaw 204, a cleaning pad actuator 210 attached to the frame 202 for actuating the opposing cleaning pads 206, first handle 212 attached to the frame 202, and a second handle 228 attached to the frame 202. The device 200 also may include a cleaning jaw actuator 214 in mechanical communication with the cleaning jaw 204 for opening and closing the cleaning jaw 204.

In some instances, the cleaning jaw 204 may include a first elongated arm 216 pivotably attached to the frame 202 at a first pivot point 218. Similarly, the cleaning jaw 204 may include a second elongated arm 220 pivotably attached to the frame 202 at a second pivot point 222. In addition, the opposing cleaning pads 206 may include a first cleaning pad 224 attached to a distal end 208 of the first elongated arm 216 and a second cleaning pad 226 attached to a distal end 208 of the second elongated arm 220.

In certain embodiments, the cleaning pad actuator 210 may be an oscillator. In some instances, the oscillator may be a pneumatic oscillator, an electrical oscillator, or gas powered oscillator. The oscillator may be any size, shape, or configuration. The oscillator may be any device capable of creating oscillating movement. The oscillator may be attached to the frame 202, the cleaning jaw 204, and/or the cleaning pads 206. In this manner, the oscillator may cause the cleaning pads 206 to oscillate, vibrate and/or rotate, which in turn may facilitate cleaning of the blades. In other instances, the oscillator may be in mechanical linkage to the cleaning pads 206 or directly attached to the cleaning pads 206. The oscillation of the oscillator may cause the cleaning pads 206 to vibrate and/or rotate. The oscillator may be actuated by one or more control buttons disposed about the first handle 212 and/or the second handle 228.

The cleaning jaw actuator 214 may be a piston. The piston may be a pneumatic piston, an electric piston, or a gas powered piston. The piston may be any size, shape, or configuration. The piston may be any device capable of creating linear movement. The piston may be attached via a mechanical linkage or directly to the first elongated arm 216 and the second elongated arm 220. In this manner, the piston may facilitate opening and closing of the cleaning jaw 204. For example, as the piston moves, the first elongated arm 216 may pivot about the first pivot point 218 and the second elongated arm 220 may pivot about the second pivot point 222. This in turn may cause the cleaning pads 206 to open and close. The piston may be actuated by one or more control buttons disposed about the first handle 212 and/or the second handle 228.

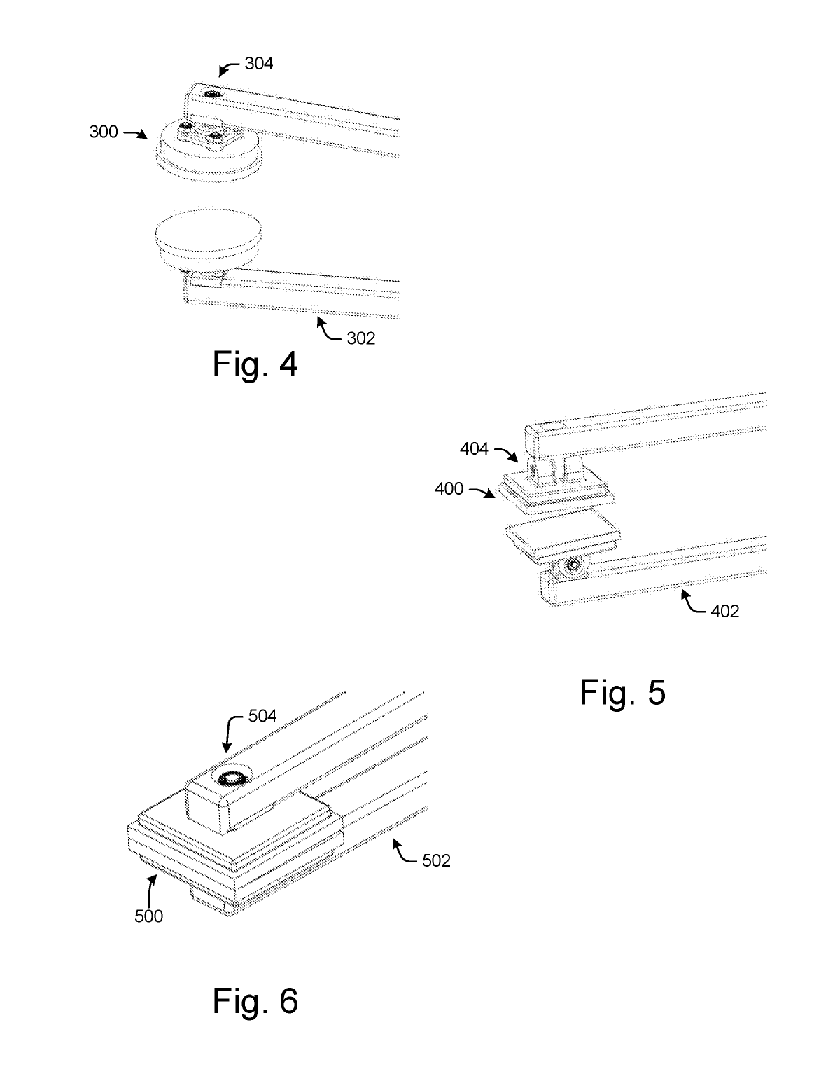

FIG. 4-6 depicts various cleaning pad configurations that may be used in conjunction with the device 100 or the device 200 disclosed above. FIG. 4 depicts cleaning pads 300. In some instances, the cleaning pads 300 may be circular cleaning pads. The cleaning pads 300 may be any size, shape, or configuration. One or both of the cleaning pads 300 may be rotatably attached to the cleaning jaw 302. For example, the cleaning pads 300 may be attached to the cleaning jaw 302 by way of a rotating joint 304. In this manner, the cleaning pads 300 may rotate due to the vibration from the oscillator. In other instances, an actuator may be in mechanical communication with the rotating joint 304 to cause the cleaning pads 300 to rotate. That is, the cleaning pads 300 may be rotary powered.

FIG. 5 depicts cleaning pads 400. In some instances, the cleaning pads 400 may be rectangular cleaning pads. The cleaning pads 400 may be any size, shape, or configuration. One or both of the cleaning pads 400 may be pivotably attached to the cleaning jaw 402. For example, the cleaning pads 400 may be attached to the cleaning jaw 402 by way of a pivot joint 404. In this manner, the cleaning pads 400 may pivot to the contours of the blades. This may facilitate good contact with the blades.

FIG. 6 depicts cleaning pads 500. In some instances, the cleaning pads 500 may be rectangular cleaning pads. The cleaning pads 500 may be any size, shape, or configuration. One or both of the cleaning pads 500 may be fixedly attached to the cleaning jaw 502. For example, the cleaning pads 500 may be attached to the cleaning jaw 502 by way of a stationary joint 504.

Any combination of the joints described above may be used to attach the cleaning pads to the cleaning jaw. For example, the cleaning pads may rotate and/or pivot. In some instances, a universal joint may be used. In some instances, the cleaning pads may be replaced. In other instances, only a portion of the cleaning pad may be replaced. For example, the cleaning pads may include replaceable pad portions attached to a stationary, rotatable, and/or pivotable member.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof. Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A device for cleaning blades in a turbomachine, the device comprising:
a frame;
a cleaning jaw pivotably attached to the frame;
opposing cleaning pads attached to a distal end of the cleaning jaw;
a cleaning pad actuator attached to the frame for actuating the opposing cleaning pads; and
at least one handle attached to the frame.

2. The device of claim 1, wherein the cleaning jaw comprises a first elongated arm pivotably attached to the frame and a second elongated arm pivotably attached to the frame.

3. The device of claim 2, wherein the opposing cleaning pads comprise a first cleaning pad attached to a distal end of the first elongated arm and a second cleaning pad attached to a distal end of the second elongated arm.

4. The device of claim 3, wherein the first cleaning pad is pivotable attached to the distal end of the first elongated arm.

5. The device of claim 3, wherein the first cleaning pad is rotatably attached to the distal end of the first elongated arm.

6. The device of claim 3, wherein the second cleaning pad is pivotable attached to the distal end of the second elongated arm.

7. The device of claim 3, wherein the second cleaning pad is rotatably attached to the distal end of the second elongated arm.

8. The device of claim 1, further comprising a cleaning jaw actuator in mechanical communication with the cleaning jaw for opening and closing the cleaning jaw.

9. The device of claim 8, wherein the cleaning jaw actuator comprises a piston.

10. The device of claim 1, wherein the at least one handle comprises two handles.

11. The device of claim 1, wherein the cleaning pad actuator comprises an oscillator.

12. A device for cleaning blades in a turbomachine, the device comprising:
a frame;
a first elongated arm pivotably attached to the frame and a second elongated arm pivotably attached to the frame;
a first cleaning pad attached to a distal end of the first elongated arm and a second cleaning pad attached to a distal end of the second elongated arm;
an oscillator in mechanical communication with the first cleaning pad and the second cleaning pad; and
at least one handle attached to the frame.

13. The device of claim 12, wherein the first cleaning pad is pivotable attached to the distal end of the first elongated arm.

14. The device of claim 12, wherein the first cleaning pad is rotatably attached to the distal end of the first elongated arm.

15. The device of claim 12, wherein the second cleaning pad is pivotable attached to the distal end of the second elongated arm.

16. The device of claim 12, wherein the second cleaning pad is rotatably attached to the distal end of the second elongated arm.

17. The device of claim 12, further comprising a piston in mechanical communication with the first elongated arm and the second elongated arm for pivoting the first elongated arm and the second elongated arm between an open position and a closed position.

18. The device of claim 12, wherein the at least one handle comprises two handles.

19. A method for cleaning a blade in a turbomachine, the method comprising:
opening a cleaning jaw pivotably attached to a frame;
positioning cleaning pads attached to a distal end of the cleaning jaw about the blade;
closing the cleaning jaw so that the cleaning pads engage opposite sides of the blade; and
actuating a cleaning pad actuator for movement of the cleaning pads to clean the blade.

20. The method of claim 19, further comprising opening the cleaning jaw to disengage the cleaning pads from the blade.
